(19) United States
(12) Patent Application Publication
(10) Pub. No.: US 2024/0349389 A1
(43) Pub. Date: Oct. 17, 2024

(54) RRC MESSAGE CONFIGURATION METHOD, APPARATUS AND SYSTEM

(71) Applicant: FUJITSU LIMITED, Kawasaki-shi Kanagawa (JP)

(72) Inventors: Su YI, Beijing (CN); Guorong LI, Beijing (CN); Meiyi JIA, Beijing (CN); Yang LU, Beijing (CN)

(73) Assignee: FUJITSU LIMITED, Kawasaki-shi Kanagawa (JP)

(21) Appl. No.: 18/757,787

(22) Filed: Jun. 28, 2024

Related U.S. Application Data
(63) Continuation of application No. PCT/CN2022/070319, filed on Jan. 5, 2022.

(51) Int. Cl. H04W 76/27; H04W 76/34

(52) U.S. Cl. CPC H04W 76/27; H04W 76/34

(57) ABSTRACT

An apparatus includes: configuring processor circuitry configured to perform autonomous configuration on a PDCP entity to which an SRB carrying a RRC message corresponds before an RRC layer of a terminal equipment submits the RRC message to a lower layer.

### CROSS-REFERENCE TO RELATED APPLICATION

This application is a continuation application of International Application PCT/CN2022/070319 filed on Jan. 5, 2022, and designated the U.S., the entire contents of which are incorporated herein by reference.

### FIELD

The present disclosure relates to the field of communications.

### BACKGROUND

The Integrated Access and Backhaul (IAB) realizes the function of a wireless relay in the Next Generation Radio Access Network (NG-RAN). The relay node is called an IAB-node, which supports both access and backhaul (BH) via the 5G New Radio (NR). All IAB-nodes are connected to an IAB-donor node via one or more hops. The multi-hop connection forms a Directed Acyclic Graph (DAG) topology with an IAB-donor node as a root node. The IAB-donor node is responsible for performing a centralized resource management, a topology management, and a routing management in an IAB network topology.

The IAB-node supports the function of gNB-DU (Distributed Unit), which is called an IAB-DU and can serve ordinary UE and IAB child nodes. The IAB-node supports some functions of user equipment (UE) at the same time, which may be called an IAB-MT (Mobile Terminal). The IAB-MT can support the functions such as a UE physical layer, an AS (access stratum) layer, a RRC (Radio Resource Control) layer and a NAS (non-access stratum) layer, and may be connected to an IAB parent node. A termination node at the network side is called an IAB-donor, which provides network access for the IAB-MT or the UE by means of backhaul or an access link. The IAB-donor is further divided into an IAB-donor-CU (Central Unit) and an IAB-donor-DU. The IAB-DU and the IAB-donor-CU are connected to each other via an F1 interface. In a scenario of standalone networking, the gNB and the IAB-donor-CU are connected to each other via an Xn interface.

In order to support multi-hop routing forwarding of packets, the IAB introduces a BAP (Backhaul Adaptation Protocol) sublayer. The BAP sublayer is located above a RLC (radio link control) sublayer and below an IP layer, and supports the functions of packet destination node and path selection, packet routing and forwarding, bearer mapping, flow control feedback, backhaul link failure notification and so on.

In the multi-hop scenario, in order to realize the relay forwarding of the packets, the IAB-node needs to determine a destination node of the packets, then determine a corresponding next hop node to the destination node according to a routing table and transmit the packets. The donor-CU configures for the IAB-node the mapping of each uplink F1-U Tunnel, Non-UE associated F1AP message, UE-associated F1AP message and Non-F1 Traffic to a BAP routing identity via FIAP (F1 application protocol) signaling. The IAB-node determines BAP routing identities corresponding to different types of uplink IP packets initiated from the IAB-node according to routing identity mapping information, and encapsulates BAP subheads containing BAP routing identity information for these uplink IP packets. The donor-CU configures for the donor-DU the mapping of different types of downlink packets to the BAP routing identities via the FIAP signaling. The donor-DU determines the BAP routing identity corresponding to the received downlink IP packets according to routing identity mapping information, and encapsulates BAP subheads containing BAP routing identity information for these downlink IP packets.

The BAP routing identity includes a destination BAP address and a path identity from the IAB-node to the donor-DU. The BAP address is also called DESTINATION in the BAP header. Each of the IAB-node and the donor-DU is configured with a BAP address.

In the NR-DC (NR-NR Dual Connectivity), F1-AP messages or F1-C related (SCTP/) IP packets encapsulated in the SCTP (Stream Control Transmission Protocol)/IP may be transmitted via BAP sublayer or via a SRB (Signaling Radio Bearer) between the IAB-node and the corresponding non-F1-termination node. When both MAG (master cell group) and SCG (secondary cell group) are configured to transmit F1-AP messages or F1-C related (SCTP/) IP packets encapsulated in the SCTP/IP, the path is selected by the implementation of the IAB.

The transmission of an F1-C (a control plane of the F1 interface) traffic or F1-C related data via the SRB is for the selection of different paths of an F1-U (a user plane traffic of the F1 interface) and F1-C, i.e., for CP-UP (Control Plane-User Plane) separation of F1. The purpose is to better ensure the transmission on the control plane, and select a shorter path or a link with better wireless channel conditions for the control plane, such as a link where a FR1 (Frequency Range 1) is located. The 3GPP has decided to support the following two NR-DC scenarios to achieve the CP-UP separation.

### Scenario 1:

As illustrated in FIG. 1, an IAB-node 11 (dual connectivity node in FIG. 1) and a secondary node 12 (F1-termination node, which is the secondary node in FIG. 1, and also the IAB-donor) exchange F1-AP messages or F1-C related (SCTP/) IP packets encapsulated in the SCTP/IP via an NR access link through a master node 13 (non-F1-termination node); and exchange F1-U traffic via a backhaul link and an SN 12 (secondary node). An IAB-node 14 is an intermediate IAB-node in the backhaul link. SRB2 is used to transmit F1-AP messages or F1-C related (SCTP/) IP packets encapsulated in the SCTP/IP between an IAB-MT (MT of the IAB-node 11) and an MN 13 (master node). These F1-AP messages or F1-C related (SCTP/) IP packets encapsulated in the SCTP/IP are transmitted as a container between the MN 13 and the SN 12 via an XnAP (Xn application protocol).

### Scenario 2:

As illustrated in FIG. 2, the IAB-node 21 and the MN 22 (F1-termination node, i.e., the IAB-donor in FIG. 2) exchange F1-AP messages or F1-C related (SCTP/) IP packets encapsulated in the SCTP/IP via an NR access link through an SN 23 (non-F1-termination node); and exchange the F1-U traffic via the backhaul link and the MN 22. The IAB-node 24 is an intermediate IAB-node in the backhaul link. Split SRB2 is used to transmit F1-AP messages or F1-C related (SCTP/) IP packets encapsulated in the SCTP/IP between IAB-MT (MT of the IAB-node 21) and the SN 23. These F1-AP messages or F1-C related (SCTP/) IP packets encapsulated in the SCTP/IP are transmitted as a container between the SN 23 and the MN 22 via the XnAP.

These F1-AP messages or F1-C related (SCTP/) IP packets encapsulated in the SCTP/IP may be transmitted via a BAP sublayer or an SRB, but it is not supported to use these two methods simultaneously on a same parent node link. If the RRC configures a BH RLC channel for transmitting the F1-C traffic in a cell group indicated for F1-C traffic transmission, the F1-AP messages or the F1-C related (SCTP/) IP packets encapsulated in the SCTP/IP are transmitted via the BAP sublayer.

In addition, the split SRB refers to an SRB between the MN and the UE in the MR-DC (Multi-Radio Dual Connectivity) and have RLC bearing for both MCG and SCG. For the split SRB, the downlink transmission path depends on the network implementation; for the uplink, the UE is configured by the RRC signaling of the MN to perform duplicate transmission using an MCG path or on the MCG and the SCG. FIG. 3 illustrates a control plane radio protocol architecture for MCG, SCG and split bearers from the perspective of UE (including IAB-MT). FIG. 4 illustrates a protocol stack of a control plane.

It should be noted that the above introduction to the technical background is only for the convenience of clear and complete explanations of the technical solutions of the present disclosure and the understanding by those skilled in the art. The above technical solutions cannot be considered to be well known to those skilled in the art merely because they are set forth in the background section of the present disclosure.

### SUMMARY

The inventor finds that the RRC message is carried by an SRB. In scenario 2, split SRB2 is used to transmit an RRC message containing F1-C related information. However, in the current protocol, PDCP-Config in an RRC reconfiguration message is configured by a network, and is used for some basic configurations of a PDCP (packet data convergence protocol) layer of the UE, in which a field primaryPath can only be set as a cell group corresponding to MCG for the SRB. In this case, split SRB2 in scenario 2 can only select an MCG path under normal circumstances (when a total amount of a PDCP data volume and a RLC data volume in a primary RLC entity and a split secondary RLC entity pending for initial transmission is less than a threshold ul-DataSplitThreshold), that is, the CP-UP separation of F1 cannot be supported in FIG. 2.

On the other hand, if the RRC message transmitted on split SRB2 contains F1-C related traffic and other information unrelated to the IAB, how to select the primary path also needs to be specified. For example, in Scenario 2, the F1-C related information indicates that the SCG link is expected to be selected, while other traditional RRC messages unrelated to the IAB indicate that the MCG link is expected to be selected according to the existing protocol, so there will be a contradiction, resulting in the failure to determine the primary path of the split bearer.
regarding at least one of the above problems, the embodiments of the present disclosure provide a method and apparatus for configuring an RRC message under dual connectivity, and a system.

According to an aspect of the embodiments of the present disclosure, there is provided an apparatus for configuring an RRC message under dual connectivity, wherein the apparatus includes:
a configuring unit configured to configure an RRC layer of an IAB-node as follows:
for an RRC message carrying an F1-C or an F1-C related traffic,
if a field flc-TransferPathNRDC in CellGroupConfig in RRC configuration indicates SCG and there is no BH RLC channel for F1-C on the SCG, the IAB-node uses split SRB2 via the SCG, regardless of primaryPath configuration of a PDCP entity of SRB2 configured by a network device;
and if the flc-TransferPathNRDC indicates both MCG and SCG and there is no BH RLC channel for F1-C on the SCG, the IAB-node may use split SRB2 via the SCG, regardless of primaryPath configuration of the PDCP entity of SRB2 configured by the network device.

According to another aspect of the embodiments of the present disclosure, there is provided an apparatus for configuring an RRC message under dual connectivity, wherein the apparatus includes:
a first configuring unit configured to configure an RRC layer of an IAB-node as follows:
for transmission of a ULCInformationTransfer message, if there is a need to transfer F1-C related information;
and if flc-TransferPathNRDC indicates SCG, or if flc-TransferPathNRDC indicates both MCG and SCG and the IAB-node chooses the SCG for transmission of the F1-C related information, using split SRB2 via the SCG, regardless of primaryPath configuration of a PDCP entity of SRB2 configured by a network device.

According to still another aspect of the embodiments of the present disclosure, there is provided an apparatus for configuring an RRC message, which is configured in a terminal equipment, wherein the apparatus includes:

a configuring unit configured to perform autonomous configuration on a PDCP entity to which an SRB carrying an RRC message corresponds before an RRC layer of the terminal equipment submits the RRC message to a lower layer.

One of the advantages of the embodiments of the present disclosure is that according to the embodiments of the present disclosure, the problem of autonomously selecting the PDCP configuration by the UE (IAB-node) is solved, so that the PDCP configuration carried by the UE can be performed for a specific RRC message, such as the selection of the primary path.

With reference to the following description and drawings, the specific embodiments of the present disclosure are disclosed in detail, and the ways in which the principles of the present disclosure can be adopted are pointed out. It should be understood that the embodiments of the present disclosure are not limited in scope thereby. The embodiments of the present disclosure include many changes, modifications and equivalents within the spirit and the scope of the appended claims.

Features described and/or illustrated for one embodiment may be used in one or more other embodiments in the same or similar manner, and combined with or substituted for features in other embodiments.

It should be emphasized that the term “comprise/include/contain” when used herein refers to the presence of a feature, an integer, a step or a component, but does not exclude the presence or addition of one or more other features, integers, steps or components.

### BRIEF DESCRIPTION OF THE DRAWINGS

Elements and features described in one drawing or one implementation of the embodiments of the present disclosure may be combined with elements and features illustrated in one or more other drawings or implementations. Moreover, throughout the drawings, like reference signs denote corresponding parts in several drawings, and may be used to denote corresponding parts used in more than one implementation.

The drawings are included to provide a further understanding of the embodiments of the present disclosure, constitute a part of the specification to illustrate the embodiments of the present disclosure, and together with the description, to explain the principles of the present disclosure. Obviously, the drawings used in the following description only illustrate some embodiments of the present disclosure, and those of ordinary skill in the art can obtain other drawings from them without paying any creative labor. In the drawings:

FIG. 1 illustrates a schematic diagram of Scenario 1 of F1-C transmission in NR-DC;

FIG. 2 illustrates a schematic diagram of Scenario 2 of F1-C transmission in NR-DC;

FIG. 3 illustrates a schematic diagram of a control plane radio protocol architecture for MCG, SCG and split bearer shown from the perspective of UE;

FIG. 4 illustrates a schematic diagram of a control plane protocol stack;

FIG. 5 illustrates a schematic diagram of a method for configuring an RRC message under dual connectivity according to an embodiment of the present disclosure;

FIG. 6 illustrates another schematic diagram of a method for configuring an RRC message under dual connectivity according to an embodiment of the present disclosure;

FIG. 7 illustrates a schematic diagram of a method for configuring an RRC message according to an embodiment of the present disclosure;

FIG. 8 illustrates a schematic diagram of an apparatus for configuring an RRC message under dual connectivity according to an embodiment of the present disclosure;

FIG. 9 illustrates another schematic diagram of an apparatus for configuring an RRC message under dual connectivity according to an embodiment of the present disclosure;

FIG. 10 illustrates a schematic diagram of an apparatus for configuring an RRC message according to an embodiment of the present disclosure;

FIG. 11 illustrates a schematic diagram of an IAB-node according to an embodiment of the present disclosure; and

FIG. 12 illustrates a schematic diagram of a terminal equipment according to an embodiment of the present disclosure.

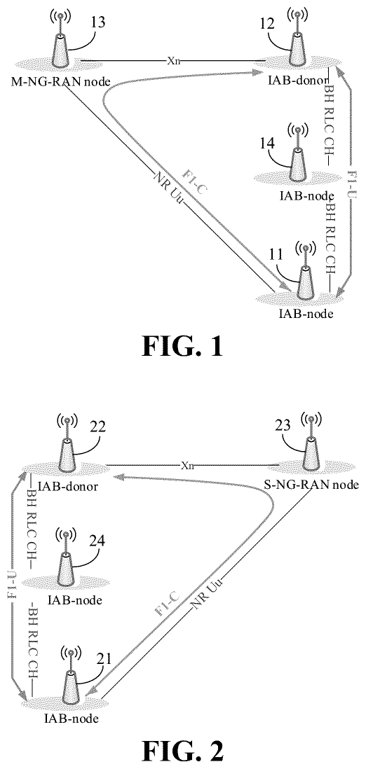

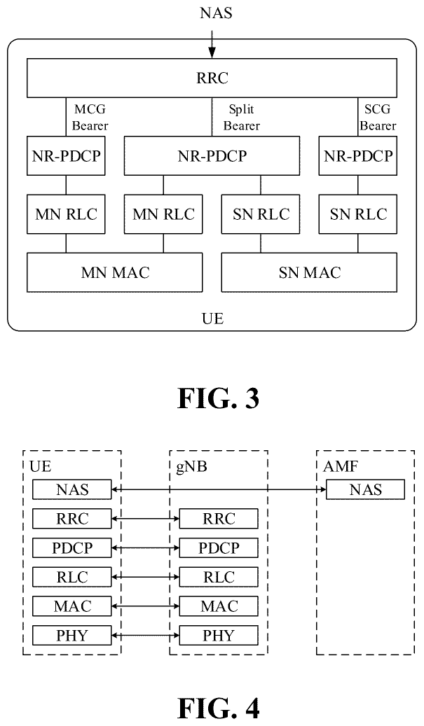

### DETAILED DESCRIPTION

The foregoing and other features of the present disclosure will become apparent from the following description with reference to the drawings. In the specification and drawings, particular embodiments of the present disclosure are specifically disclosed, which show some embodiments in which the principles of the present disclosure can be adopted. It should be understood that the present disclosure is not limited to the described embodiments, but on the contrary, includes all modifications, variations and equivalents falling within the scope of the appended claims.

In the embodiments of the present disclosure, the terms “first”, “second” and the like are used to nominally distinguish between different elements, but do not denote a spatial arrangement, a temporal order, or the like of such elements, and such elements should not be limited thereby. The term “and/or” includes any and all combinations of one or more of the associated listed terms. The terms “comprise”, “include”, “has” and the like specify the presence of stated features, elements, members, or components, but do not exclude the presence or addition of one or more other features, elements, members, or components.

In the embodiments of the present disclosure, the singular forms “a/an”, “the” and the like include the plural forms, and should be broadly understood as “a type of” or “a category of” rather than being limited to the meaning of “one”. Furthermore, the term “said” should be understood to include both singular and plural forms, unless the context clearly indicates otherwise. In addition, the term “according to” should be understood as “at least partially according to . . . ”, and the term “based on” should be understood as “at least partially based on”, unless the context clearly indicates otherwise.

In the embodiments of the present disclosure, the term “communication network” or “wireless communication network” may refer to a network conforming to any communication standard, such as Long Term Evolution (LTE), LTE-Advanced (LTE-A), Wideband Code Division Multiple Access (WCDMA), High-speed Packet Access (HSPA), and the like.

Moreover, a communication between devices in a communication system may be performed according to a communication protocol at any stage, including, but not limited to, 1G (generation), 2G, 2.5G, 2.75G, 3G, 4G, 4.5G, and 5G, New Radio (NR) in the future, etc., and/or any other communication protocol currently known or to be developed in the future.

In the embodiments of the present disclosure, the term “network device” refers to, for example, a device in a communication system which connects a terminal equipment to a communication network and provides a service for the terminal equipment. The network device may include, but is not limited to, a Base Station (BS), an Access Point (AP), a Transmission Reception Point (TRP), a broadcast transmitter, a Mobile Management Entity (MME), a gateway, a server, a Radio Network Controller (RNC), a Base Station Controller (BSC), and the like.

The base station may include, but is not limited to, a Node B (NodeB or NB), an evolved Node B (eNode B or eNB) and a 5G base station (gNB), etc., and may further include a Remote Radio Head (RRH), a Remote Radio Unit (RRU), a relay or a low-power node (e.g., femto, pico, etc.), some or all functions of which may be included by the term “base station”, and each base station may provide a communication coverage for a particular geographical area. The term “cell” may refer to a base station and/or a coverage area thereof, depending on the context in which the term is used.

In the embodiments of the present disclosure, the term “User Equipment (UE)” refers to, for example, an equipment that accesses a communication network through a network device and receives a network service, and may also be called “Terminal Equipment (TE)”. The terminal equipment may be stationary or movable, and may also be referred to as a Mobile Station (MS), a terminal, a user, a Subscriber Station (SS), an Access Terminal (AT), a station, or the like.

The terminal equipment may include, but is not limited to, a Cellular Phone, a Personal Digital Assistant (PDA), a wireless modem, a wireless communication device, a handheld device, a machine communication device, a laptop computer, a cordless phone, a smart phone, a smart watch, a digital camera, IAB-MT, and so on.

For another example, in the scenarios such as the Internet of Things (IoT), the terminal equipment may also be a machine or apparatus for monitoring or measuring, for example including but not limited to a Machine Type Communication (MTC) terminal, a vehicle communication terminal, a Device to Device (D2D) terminal, a Machine to Machine (M2M) terminal, and so on.

Various embodiments of the present disclosure will be described below with reference to the drawings. These embodiments are only exemplary, rather than limitations to the present disclosure.

In the embodiments of the present disclosure, for the convenience of description, a deployment scenario of 5G multi-hop IAB network is taken as an example, that is, multiple UEs are connected to the IAB-donor via the multi-hop IAB-nodes, and finally access to the 5G network. However, the present disclosure is not limited thereby. For example, the embodiments of the present disclosure may also be applied to the ordinary 5G NR or the subsequent evolution communication network deployment.

### Embodiments of a First Aspect

The embodiments of the present disclosure provide a method for configuring an RRC message under dual connectivity, which is described from a side of an IAB-node.

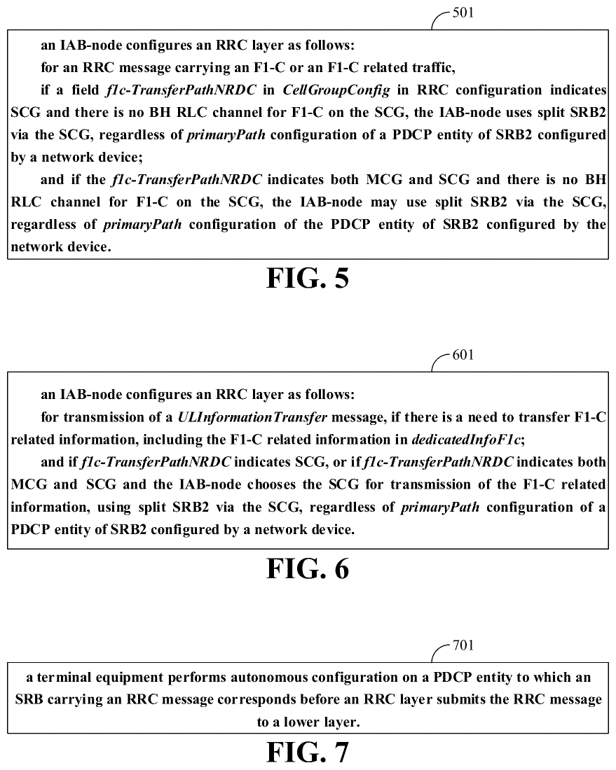

FIG. 5 illustrates a schematic diagram of a method for configuring an RRC message under dual connectivity according to an embodiment of the present disclosure. Referring to FIG. 5, the method includes:
501: an IAB-node configures an RRC layer as follows:
for an RRC message carrying an F1-C or an F1-C related traffic,
if a field flc-TransferPathNRDC in CellGroupConfig in RRC configuration indicates SCG and there is no BH RLC channel for F1-C on the SCG, the IAB-node uses split SRB2 via the SCG, regardless of primaryPath configuration of a PDCP entity of SRB2 configured by a network device;
and if the flc-TransferPathNRDC indicates both MCG and SCG and there is no BH RLC channel for F1-C on the SCG, the IAB-node may use split SRB2 via the SCG, regardless of primaryPath configuration of the PDCP entity of SRB2 configured by the network device.

In the current standard, a parameter called flc-TransferPathNRDC is configured for the IAB-node in the RRC signaling (also called RRC message). This parameter flc-TransferPathNRDC is a field in CellGroupConfig in RRC configuration, and is used for a network to indicate the IAB-node in an NR-DC state to select an uplink transmission path of F1-C, i.e., a cell group. This parameter specifies the transmission path that the IAB-MT (i.e., the IAB-node) of the NR-DC should use when transmitting F1-C packets to an IAB-donor-CU. If this parameter of the IAB-MT is configured as “mcg”, the IAB-MT can only use the MCG for F1-C transmission. If this parameter of the IAB-MT is configured as “scg”, the IAB-MT can only use the SCG for F1-C transmission. If this parameter of the IAB-MT is configured as “both”, it is up to the IAB-MT to choose the MCG or the SCG for F1-C transmission. In addition, the appellation of this parameter is not limited in the present disclosure, and it may be any other appellation to achieve the above function or purpose.

In addition, an IE (information element) RadioBearerConfig in the RRC message is used to add, modify or release signaling and/or data radio bearer. The IE RadioBearerConfig carries a PDCP parameter, and an IE PDCP-Config of the PDCP parameter contains a field primaryPath, which is used to indicate a cell group ID and a LCID (Logical Channel IDentification) of a primary RLC entity for uplink data transmission when the PDCP entity is associated with more than one RLC entity. In the current protocol, for the SRB, cell group IDs in primaryPath only support the cell group ID corresponding to the MCG. The network uses the logical channels of different cell groups to indicate the cell group of the split bearer.

According to the embodiments of the present disclosure, when the RRC message of the IAB-MT carries the F1-C or the F1-C related traffic, flc-TransferPathNRDC indicates “scg”, and there is no BH RLC channel for the F1-C on the SCG link, the split SRB2 via the SCG is used regardless of the primaryPath configuration of the PDCP entity of the SRB2; when the RRC message of the IAB-MT carries the F1-C or the F1-C related traffic, flc-TransferPathNRDC indicates “both”, and there is no BH RLC channel for the F1-C on the SCG link, the split SRB2 via SCG may be used regardless of the primaryPath configuration of the PDCP entity of the SRB2 (the SRB2 or the traditional split SRB2 may also be used when the MCG is not configured with the BH RLC channel for the F1-C, which depends on the selection of the implementation of the IAB-MT). Therefore, the problem of autonomously selecting the PDCP configuration by the IAB-node is solved, so that the PDCP configuration, such as the selection of the primary path, may be performed for a specific RRC message.

In some embodiments, after the RRC message is transmitted, the primaryPath configuration is recovered to the original value. That is, the primaryPath configuration is recovered to the original configuration after the RRC message carrying the F1-C or the F1-C related traffic is transmitted. Thus, the configuration and/or transmission of the subsequent RRC message will not be affected.

In some embodiments, the IAB-node configures the IE flc-TransferPathNRDC′ of the RRC layer thereof as described above. That is, the above configuration is located in the description of the IE flc-TransferPathNRDC of the RRC layer in the standard. Therefore, the action of the IAB-node can be specified, and the change to the current standard is small.

The above content only describes the action of the IAB-node related to the embodiments of the present disclosure, and for other actions of the IAB-node, please refer to the related art.

For example, in some embodiments, the IAB-node is configured with the MCG and the SCG, and exchanges F1-AP messages or F1-C related IP packets sealed in an SCTP and/or IP with an MN via an SN using an NR access network, and exchanges F1-U traffics with the MN using a backhaul link.

For another example, in some embodiments, the split SRB2 is used to transmit the F1-AP messages or the F1-C related IP packets sealed in the SCTP and/or IP between the IAB-node and the SN, and the F1-AP messages or the F1-C related IP packets sealed in the SCTP and/or IP are transferred as a container between the SN and the MN via an XnAP.

In the embodiments of the present disclosure, how the IAB-node processes in the PDCP layer depends on the specific implementation of the IAB-node (IAB-MT), and is not limited herein.

The above embodiments only exemplify the embodiments of the present disclosure, while the present disclosure is not limited thereto, and appropriate modifications can be made on the basis of the above embodiments. For example, each of the above embodiments may be used alone, or one or more of which may be combined.

According to the method of the embodiments of the present disclosure, a CP-UP separation in Scenario 2 can be supported. In this way, in a case where the master node is the IAB-donor, a shorter path or a link with better wireless channel conditions is selected for the control plane, such as a link where the FR1 is located is selected, so that the transmission on the control plane can be better guaranteed and the management efficiency and reliability can be improved.

### Embodiments of a Second Aspect

The embodiments of the present disclosure provide a method for configuring an RRC message under dual connectivity, which is described from a side of an IAB-node.

FIG. 6 illustrates another schematic diagram of a method for configuring an RRC message under dual connectivity according to an embodiment of the present disclosure. Referring to FIG. 6, the method includes:

601: an IAB-node configures an RRC layer as follows:
for transmission of a ULInformationTransfer message, if there is a need to transfer F1-C related information, including the F1-C related information in dedicatedInfoFlc;
and if flc-TransferPathNRDC indicates SCG, or if flc-TransferPathNRDC indicates both MCG and SCG and the IAB-node chooses the SCG for transmission of the F1-C related information, using split SRB2 via the SCG, regardless of primaryPath configuration of a PDCP entity of aSRB2 configured by a network device.

In the current standard, it has been agreed to carry an F1-C and a related traffic thereof in the ULInformationTransfer message of the RRC message.

In the embodiments of the present disclosure, the IE DedicatedInfoFlc is used to forward IB-DU-specific F1-C related information between the network and the IAB-node. The carried information includes F1AP messages or F1-C related (SCTP/) IP packets encapsulated in an SCTP/IP. The message is transparent to the RRC layer. In addition, the appellation of the IE is not limited in the present disclosure, and it may be any other appellation to achieve the above function or purpose.

In some embodiments, when defining an action related to the transmission of the ULInformationTransfer message, one or more steps may be added for the IAB-MT when setting the contents of ULInformationTransfer. That is, for the IAB-MT, if the F1-C related information needs to be transmitted, when the F1-C related information is included in dedicatedInfoFlc, one or more of the following steps are performed:
if flc-TransferPathNRDC′ indicates “scg”, or if flc-TransferPathNRDC indicates “both” and IAB-MT chooses the SCG for transmission of the F1-C related information:
including no information unrelated to the IAB in the same message; and/or
using the split SRB2 via the SCG, regardless of the primaryPath configuration of the PDCP entity of the SRB2; and/or;
restoring the primaryPath configuration to the original configuration after transmitting the message.

For example, the RRC standard may be enhanced in TS 38.331. An example of modifying the standard is as follows:

The UE shall set the contents of the ULInformationTransfer message as
follows:

| 1> | if the upper layer provides NAS PDU: | |
|---|---|---|
| | 2> | set the dedicatedNAS-Message to include the information |
| | | received from upper |
| | | layers; |
| 1> | for the IAB-MT, if there is a need to transfer F1-C related | |
| | information: | |
| | 2>include the dedicatedInfoF1c; | |
| | 2> | if f1c-TransferPathNRDC indicates ‘scg’; or: |
| | 2> | if f1c-TransferPathNRDC indicates ‘both’ and IAB-MT |
| | | chooses SCG for F1- |
| | | C transfer: |
| | 3> | do not include other information unrelated to IAB in |
| | | the same message; |
| | 3> | use split SRB2 via SCG regardless of the primaryPath |
| | | for the PDCP entity |

of SRB2. The primaryPath configuration is reverted to
the original value after
transmitting this message.

| | |
|---|---|
| 1> | submit the ULInformationTransfer message to lower layers |
| | for transmission, upon |
| | which the procedure ends. |

In the above embodiment, the configuration of the PDCP layer depends on the specific implementation of the IAB-node (IAB-MT), and is not limited herein.

In some other embodiments, if the UE/IAB-MT wants to specify primaryPath for a specific RRC message (e.g. an RRC message carrying the F1-C related information), the RRC layer may autonomously set primaryPath of the PDCP entity of the SRB2 (e.g., set as referring to the SCG) when submitting the RRC message (e.g., the RRC message carrying the F1-C related information) to a lower layer (i.e., the PDCP layer), and give an indication to the lower layer to indicate that the set primaryPath is only for the RRC message.

For example, where defining an action related to transmission of the ULInformationTransfer message, one or more of the following steps may be added for the IAB-MT when setting the contents of ULInformationTransfer. That is, for the IAB-MT, if the F1-C related information needs to be transmitted, the F1-C related information is included in dedicatedInfoFlc, and one or more of the following steps are performed:
if flc-TransferPathNRDC indicates “scg”, or flc-TransferPathNRDC indicates “both” and the IAB-MT chooses the SCG to transmit the F1-C related information:
including no information unrelated to the IAB in the same message; and/or
setting primaryPath of the PDCP entity of the SRB2 to refer to the SCG; and/or
indicating to a lower layer that the primaryPath configuration is only used for the message.

For example, the RRC standard may be enhanced in TS 38.331. An example of modifying the standard is as follows:

The UE shall set the contents of the ULInformationTransfer message as
follows:

| 1> | if the upper layer provides NAS PDU: | |
|---|---|---|
| | 2> | set the dedicatedNAS-Message to include the information |
| | | received from upper |
| | | layers; |
| 1> | for the IAB-MT, if there is a need to transfer F1-C related | |
| | information: | |
| | 2>include the dedicatedInfoF1c; | |
| | 2> | if f1c-TransferPathNRDC indicates ‘scg’; or: |
| | 2> | if f1c-TransferPathNRDC indicates ‘both’ and IAB-MT |
| | | chooses SCG for F1- |
| | | C transfer: |
| | 3> | do not include other information unrelated to IAB in the |
| | | same message; |
| | 3> | set the primaryPath for the PDCP entity of SRB2 to refer |
| | | to the SCG; |
| | 3> | indicate to lower layer that the primaryPath configuration |
| | | is only for this |

message.

| | |
|---|---|
| 1> | submit the ULInformationTransfer message to lower layers for |
| | transmission, upon |
| | which the procedure ends. |

In the above embodiments, “setting primaryPath of the PDCP entity of the SRB2 to refer to the SCG” also means “using split SRB2 via the SCG, regardless of primaryPath configuration of a PDCP entity of SRB2 configured by a network device”.

In the above embodiment, “including no information unrelated to the IAB in the same message” is in order not to affect other traditional RRC messages unrelated to the IAB, i.e., the messages unrelated to F1-C. These messages still select the MCG link according to the existing protocol.

In the above embodiment, the IAB-node (IAB-MT) may also configure the PDCP layer as follows:
when submitting a PDCP PDU (Protocol Data Unit) to a lower layer, a transmitting PDCP entity submits the PDCP PDU to a primary RLC entity;
if a high layer indicates that the primaryPath configuration is only used for the message, after submitting the PDCP PDU to the primary RLC entity, setting the primary RLC entity as an RLC entity on the MCG.

That is, in a case where the PDCP entity receives a PDCP SDU (Service Data Unit) submitted by the upper layer and the transmitting PDCP entity is ready to submit the PDCP PDU to the lower RLC entity, if the upper layer indicates that the configuration of the primary RLC entity (i.e., primaryPath set by the RRC layer) is only for the current message, after the PDCP PDU is submitted to the currently set primary RLC entity, the primary RLC entity is set as the RLC entity on the MCG, i.e., the original configuration is recovered,

For example, the PDCP standard may be enhanced in TS 38.323. An example of modifying the standard is as follows:

When submitting a PDCP PDU to lower layer, the transmitting PDCP
entity shall:

| - | if the transmitting PDCP entity is associated with one RLC entity: | |
|---|---|---|
| | - | submit the PDCP PDU to the associated RLC entity; |
| - | else, if the transmitting PDCP entity is associated with at least two | |
| | RLC entities: | |
| | - | if the PDCP duplication is activated: |

...

| | |
|---|---|
| - | else: |

| | |
|---|---|
| - | if the split secondary RLC entity is configured; and |
| - | if the transmitting PDCP entity is not associated with a |
| | DAPS bearer; and |
| - | if the total amount of PDCP data volume and RLC data |
| | volume pending for |

| initial transmission (as specified in TS 38.322 [5]) in the | |
|---|---|
| primary RLC entity | |
| and the split secondary RLC entity is equal to or larger than | |
| ul-DataSplitThreshold: | |
| - | submit the PDCP PDU to either the primary RLC entity |
| | or the split |

secondary RLC entity;

| - | else, if the transmitting PDCP entity is associated with the |
|---|---|
| | DAPS bearer: |
| | ... |
| - | else: |

| | |
|---|---|
| - | submit the PDCP PDU to the primary RLC entity. |
| - | if indicated from higher layer that the primary RLC |
| | entity configuration |

is only for this message:
- set the primary RLC entity to the RLC entity on MCG.

In still some other embodiments, similar to the previous embodiment, it is also possible that the RRC layer does not modify the primaryPath configuration of the PDCP entity of the SRB2, but directly indicates the lower layer to use the SCG path to transmit the RRC message. That is, the IAB-node indicates the lower layer to transmit the above message using the SCG path.

That is, “setting primaryPath of the PDCP entity of the SRB2 to refer to the SCG” in the previous embodiment is replaced by “indicating the lower layer to use the SCG path to transmit the message”. Other descriptions of the RRC layer are the same as those in the previous embodiment.

In the above embodiment, when receiving, from the upper layer, a PDCP SDU and an indication for using SCG path for the PDCP SDU, the PDCP entity ignores the configured primary RLC entity (in a case that a total amount of a PDCP data volume and an RLC data volume in the primary RLC entity and the split secondary RLC entity pending for initial transmission is less than a threshold ul-DataSplitThreshold) and directly submits a corresponding PDCP PDU to a secondary RLC entity (the RLC entity on the SCG). That is, the IAB-node may configure the PDCP layer as follows: when receiving, from the upper layer, a PDCP SDU and an indication for using the SCG for an SDU (ignoring the configured primary RLC entity), submitting a corresponding PDCP PDU to a secondary RLC entity.

For example, the PDCP standard may be enhanced in TS 38.323. An example of modifying the standard is as follows:

When submitting a PDCP PDU to lower layer, the transmitting PDCP
entity shall:

| - | if the transmitting PDCP entity is associated with one RLC entity: | |
|---|---|---|
| | - | submit the PDCP PDU to the associated RLC entity; |
| - | else, if the transmitting PDCP entity is associated with at least two | |
| | RLC entities: | |
| | - | if the PDCP duplication is activated: |

...

| | |
|---|---|
| - | else: |

| | |
|---|---|
| - | if the split secondary RLC entity is configured; and |
| - | if the transmitting PDCP entity is not associated with a |
| | DAPS bearer; and |
| - | if the total amount of PDCP data volume and RLC data |
| | volume pending for |

| initial transmission (as specified in TS 38.322 [5]) in the | |
|---|---|
| primary RLC entity and | |
| the split secondary RLC entity is equal to or larger than | |
| ul-DataSplitThreshold: | |
| - | submit the PDCP PDU to either the primary RLC entity |
| | or the split secondary |

RLC entity;

| - | else, if the transmitting PDCP entity is associated with the |
|---|---|
| | DAPS bearer: |
| | ... |
| - | else: |

| | |
|---|---|
| - | if indicated from higher layer to use SCG for this |
| | message: |

| | |
|---|---|
| - | submit the PDCP PDU to the RLC entity on the SCG. |

| | |
|---|---|
| - | else: |

- submit the PDCP PDU to the primary RLC entity.

In still some other embodiments, a field (called a first configuration) may be added in PDCP-Config IE to indicate that an PDCP-Config (or primaryPath in PDCP-Config) of a bearer of the current configuration is an autonomous configuration from a local node (i.e., it is not a configuration from the network side, namely, it is a configuration made by the upper layer (RRC layer) of the local node itself for the PDCP layer). It is only necessary to apply the primaryPath configuration in the IE for a next message needing to be transmitted via the bearer (i.e., the next PDCP SDU from the upper layer received by the corresponding PDCP entity).

For example, the field more ThanOneRLC of PDCP-Config may be added with a field, for example called autonomousConfig, which is a Boolean value. If the value is set to TRUE, it indicates that primaryPath in the IE is an autonomous configuration, also called a temporary configuration. If the value is set to FALSE, or autonomousConfig is not configured, the configuration is made according to the related art.

For example, the above new indication field may be defined as follows:

| | |
|---|---|
| moreThanOneRLC | SEQUENCE { |
| primaryPath | SEQUENCE { |

| | cellGroup | CellGroupId |
|---|---|---|
| OPTIONAL, | -- Need R | |
| | logicalChannel | LogicalChannelIdentity |
| OPTIONAL | -- Need R | |
| | autonomousConfig | BOOLEAN |

| | |
|---|---|
| Optional | -- Need R |

},

| | |
|---|---|
| ul-DataSplitThreshold | UL-DataSplitThreshold |

| | |
|---|---|
| OPTIONAL, | -- Cond SplitBearer |

| | | |
|---|---|---|
| pdcp-Duplication | BOOLEAN | OPTIONAL |

-- Need R
}

In the above embodiment, if the UE/IAB-MT wants to specify primaryPath for a specific RRC message (e.g. an RRC message carrying the F1-C related information), the RRC layer may, when submitting the RRC message (e.g., the message carrying the F1-C related information) to the lower layer (i.e., the PDCP layer), autonomously set primaryPath of the PDCP entity of the SRB2 (e.g., set as referring to the SCG), and setting autonomousConfig of the PDCP entity of the SRB2 to be TRUE at the same time, to indicate that the set primaryPath is only for a next message needing to be transmitted via the bearer (i.e., an uplink message). The RRC layer transmits the F1-C related message immediately after configuring primaryPath and autonomousConfig, so the next message on the SRB2 is the RRC message carrying the F1-C related information.

For example, when defining an action related to transmission of the ULInformationTransfer message, one or more of the following steps may be added for the IAB-MT when setting the contents of ULInformationTransfer. That is, for the IAB-MT, if the F1-C related information needs to be transmitted, the F1-C related information is included in dedicatedInfoFlc, and one or more of the following steps are performed:
if flc-TransferPathNRDC indicates “scg”, or flc-TransferPathNRDC indicates “both” and the IAB-MT chooses the SCG to transmit the F1-C related information:
including no information unrelated to the IAB in the same message; and/or
setting primaryPath of the PDCP entity of the SRB2 to refer to the SCG; and/or
setting autonomousConfig of the PDCP entity of the SRB2 to be TURE.

For example, the RRC standard may be enhanced in TS 38.331. An example of modifying the standard is as follows:

The UE shall set the contents of the ULInformationTransfer message as
follows:

| 1> | if the upper layer provides NAS PDU: | |
|---|---|---|
| | 2> | set the dedicatedNAS-Message to include the information |
| | | received from upper |
| | | layers; |
| 1> | for the IAB-MT, if there is a need to transfer F1-C related | |
| | information: | |
| | 2>include the dedicatedInfoF1c; | |
| | 2> | if f1c-TransferPathNRDC indicates ‘scg’; or: |
| | 2> | if f1c-TransferPathNRDC indicates ‘both’ and IAB-MT |
| | | chooses SCG for F1- |
| | | C transfer: |
| | 3> | do not include other information unrelated to IAB in |
| | | the same message; |
| | 3> | set the primaryPath for the PDCP entity of SRB2 to |
| | | refer to the SCG; |
| | 3> | set the autonomousConfig for the PDCP entity of SRB2 |
| | | to be TRUE. |

| | |
|---|---|
| 1> | submit the ULInformationTransfer message to lower layers for |
| | transmission, upon |

which the procedure ends.

In the above embodiment, “setting primaryPath of the PDCP entity of the SRB2 to refer to the SCG” also means “using split SRB2 via the SCG, regardless of primaryPath configuration of a PDCP entity of SRB2 configured by a network device”.

In the above embodiments, similarly, “including no information unrelated to the IAB in the same message” is in order not to affect other traditional RRC messages unrelated to the IAB. These messages still select the MCG link according to the existing protocol.

In the above embodiments, the IAB-node (IAB-MT) may also configure the PDCP layer as follows:
when the PDCP PDU is submitted to a lower layer, a transmitting PDCP entity submits the PDCP PDU to a primary RLC entity;
if the first configuration is configured and is set to TRUE, at least one of the following actions is performed:
setting the primary RLC entity as an RLC entity on the MCG after submitting the PDCP PDU to the primary RLC entity;
setting the first configuration to be FALSE.

In the above embodiment, taking that the first configuration is autonomousConfig as an example, after the PDCP entity receives the PDCP SDU submitted by the upper layer and the transmitting PDCP entity submits the PDCP PDU to the lower primary RLC entity, if autonomousConfig is set to TRUE, the primary RLC entity is set as the RLC entity on the MCG, i.e., the original configuration is recovered. Optionally, autonomousConfig is set to be FALSE.

For example, the PDCP standard may be enhanced in TS 38.323. An example of modifying the standard is as follows:

When submitting a PDCP PDU to lower layer, the transmitting PDCP
entity shall:

| - | if the transmitting PDCP entity is associated with one RLC entity: | |
|---|---|---|
| | - | submit the PDCP PDU to the associated RLC entity; |
| - | else, if the transmitting PDCP entity is associated with at least two | |
| | RLC entities: | |
| | - | if the PDCP duplication is activated: |

...

| | |
|---|---|
| - | else: |

| | |
|---|---|
| - | if the split secondary RLC entity is configured; and |
| - | if the transmitting PDCP entity is not associated with a |
| | DAPS bearer; and |
| - | if the total amount of PDCP data volume and RLC data |
| | volume pending for |

| initial transmission (as specified in TS 38.322 [5]) in the | |
|---|---|
| primary RLC entity | |
| and the split secondary RLC entity is equal to or larger than | |
| ul-DataSplitThreshold: | |
| - | submit the PDCP PDU to either the primary RLC |
| | entity or the split |

secondary RLC entity;

| - | else, if the transmitting PDCP entity is associated with the |
|---|---|
| | DAPS bearer: |
| | ... |
| - | else: |

| | |
|---|---|
| - | submit the PDCP PDU to the primary RLC entity. |
| - | if autonomousConfig is configured and is TRUE: |

- set the primary RLC entity to the RLC entity on MCG;
- set autonomousConifig to be FALSE;

In still some other embodiments, similar to the previous embodiment, it is also possible that the RRC layer does not modify primaryPath of the PDCP entity of the SRB2, but directly indicates the lower layer to use the SCG path to transmit a next message needing to be transmitted via the bearer, via a new configured field in PDCP-Config (may be called autonomousConfig or may also be called useSCG, etc.). That is, the IAB-node (IAB-MT) indicates to the lower layer to use the SCG path to transmit the next message needing to be transmitted via the current bearer, via the new configured field (called a second configuration).

That is, “setting primaryPath of the PDCP entity of the SRB2 to refer to the SCG” in the previous embodiment is replaced by “setting the second configuration (e.g., useSCG) in the PDCP configuration of the RRC layer of the IAB-node to be TRUE”. Other descriptions of the RRC layer are the same as those in the previous embodiment.

In the above embodiments, when receiving the PDCP SDU from the upper layer, the PDCP entity determines whether the new configuration (e.g. useSCG) is set to TRUE, and if so, that is, the SCG path should be used for transmitting the SDU, the configured primary RLC entity is ignored and the corresponding PDCP PDU is directly submitted to the secondary RLC entity (the RLC entity on the SCG). Then, the configuration corresponding to the new field is set to be FALSE. That is, the IAB-node may configure the PDCP layer as follows: when receiving the PDCP SDU from the upper layer, if the second configuration is set to TRUE, performing at least one of the following actions:
ignoring a configured primary RLC entity and submitting a corresponding PDCP PDU to a secondary RLC entity;
setting the second configuration to be False.

For example, the PDCP standard may be enhanced in TS 38.323. An example of modifying the standard is as follows:

When submitting a PDCP PDU to lower layer, the transmitting PDCP
entity shall:

| - | if the transmitting PDCP entity is associated with one RLC entity: | |
|---|---|---|
| | - | submit the PDCP PDU to the associated RLC entity; |
| - | else, if the transmitting PDCP entity is associated with at least two | |
| | RLC entities: | |
| | - | if the PDCP duplication is activated: |

...

| | |
|---|---|
| - | else: |

| | |
|---|---|
| - | if the split secondary RLC entity is configured; and |
| - | if the transmitting PDCP entity is not associated with a |
| | DAPS bearer; and |
| - | if the total amount of PDCP data volume and RLC data |
| | volume pending for |

| initial transmission (as specified in TS 38.322 [5]) in the | |
|---|---|
| primary RLC entity | |
| and the split secondary RLC entity is equal to or larger than | |
| ul-DataSplitThreshold: | |
| - | submit the PDCP PDU to either the primary |
| | RLC entity or the split |

secondary RLC entity;

| - | else, if the transmitting PDCP entity is associated with |
|---|---|
| | the DAPS bearer: |
| | ... |
| - | else: |

| | |
|---|---|
| - | if useSCG is configured and is TRUE: |

| | |
|---|---|
| - | submit the PDCP PDU to the RLC entity |
| | on the SCG; |
| - | set useSCG to be FALSE. |

| | |
|---|---|
| - | else: |

- submit the PDCP PDU to the primary RLC entity.

Only the actions of the IAB-node related to the embodiments of the present disclosure are described as above, and for other actions of the IAB-node, please refer to the related art.

For example, in some embodiments, the IAB-node is configured with the MCG and the SCG, and exchanges F1-AP messages or F1-C related IP packets sealed in an SCTP and/or IP with an MN via an SN using an NR access network, and exchanges F1-U traffics with the MN using a backhaul link.

For another example, in some embodiments, the split SRB2 is used to transmit the F1-AP messages or the F1-C related IP packets sealed in the SCTP and/or IP between the IAB-node and the SN, and the F1-AP messages or the F1-C related IP packets sealed in the SCTP and/or IP are transferred as a container between the SN and the MN via an XnAP.

The above embodiments only exemplify the embodiments of the present disclosure, while the present disclosure is not limited thereto, and appropriate modifications can be made on the basis of the above embodiments. For example, each of the above embodiments may be used alone, or one or more of which may be combined.

According to the method of the embodiments of the present disclosure, a CP-UP separation in Scenario 2 can be supported. In this way, in a case where the master node is the IAB-donor, a shorter path or a link with better wireless channel conditions is selected for the control plane, such as a link where the FR1 is located is selected, so that the transmission on the control plane can be better guaranteed and the management efficiency and reliability can be improved.

### Embodiments of a Third Aspect

The embodiments of the present disclosure provide a method for configuring an RRC message, which is described from a side of a terminal equipment.

FIG. 7 illustrates a schematic diagram of a method for configuring an RRC message according to an embodiment of the present disclosure. Referring to FIG. 7, the method includes:

701: a terminal equipment performs autonomous configuration on a PDCP entity to which an SRB carrying an RRC message corresponds before an RRC layer submits the RRC message to a lower layer.

In the embodiment of the present disclosure, the terminal equipment autonomously configures the PDCP parameters for itself, and is not limited to the aforementioned primaryPath.

In some embodiments, a field (called a third configuration) may be added in PDCP-Config 1E to indicate that PDOP-Config of the bearer of the current configuration is an autonomous configuration from a local node (i.e., it is not a configuration from the network side). It is only necessary to apply configuration parameters in the IE for a next message needing to be transmitted via the bearer (i.e., the next PDCP SDU from the upper layer received by the corresponding PDCP entity).

For example, PDCP-Config may be added with a field, for example called autonomousConfig, which is a Boolean value. If the value is set to TRUE, it indicates that the parameter in the IE is an autonomous configuration, also called a temporary configuration. If the value is set to FALSE, or autonomousConfig is not configured, the configuration is made according to the related art.

In some embodiments, when receiving a PDCP configuration in which autonomousConfig is set to TRUE, the PDCP entity acquires that the autonomous configuration is only used temporarily for a next PDCP SDU from the upper layer. That is, when the upper layer requests PDCP reconfiguration and the third configuration (autonomousConfig) is set to TRUE, the terminal equipment may perform one or more of the following steps:
storing reconfiguration information as a temporary configuration parameter;
associating a COUNT value (TX_NEXT) of a next PDCP SDU to be transmitted with the temporary configuration parameter, to indicate that the next PDCP SDU to be transmitted uses the temporary configuration parameter.

For example, the part of PDCP reconfiguration may be enhanced in TS 38.323. An example of modifying the standard is as follows:

When upper layers request a PDCP reconfiguration and autonomousConfig
is TRUE,
UE shall:

| | |
|---|---|
| - | store the reconfiguration in a temporary config; |
| - | associate TX_NEXT with this temporary config indicating |
| | that the next |
| | PDCP SDU will use the temporary config. |

In the above embodiments, during a transmitting operation of PDCP entity data transmission, the PDCP entity receives the PDCP SDU submitted by the upper layer, and if TX_NEXT is associated with the temporary configuration (i.e., the temporary configuration parameter), the temporary configuration parameter is used in the process of submitting the PDCP SDU.

In the above embodiments, after the transmitting PDCP entity submits the PDCP PDU to the lower primary RLC entity, if TX_NEXT-1 is associated with the temporary configuration (i.e., the temporary configuration parameter), the temporary configuration parameter is released. Here, TX_NEXT-1 is because TX_NEXT is subjected to an operation of adding by 1 in the process of submitting to the lower layer.

For example, the transmitting operation part of the PDCP entity data transmission may be enhanced in TS 38.323. An example of modifying the standard is as follows:

For a PDCP SDU received from upper layers, the transmitting PDCP entity shall:

| - | | associate the COUNT value corresponding |
|---|---|---|
| | | to TX_NEXT to this PDCP SDU; |
| - | if TX_NEXT is associated with a temporary config: | |
| | - | use this temporary config for |
| | | submitting this PDCP SDU; |

...

| | |
|---|---|
| - | increment TX_NEXT by one; |

...

When submitting a PDCP PDU to lower layer, the transmitting PDCP entity shall:

...

| - | if TX_NEXT-1 is associated with a temporary config: | |
|---|---|---|
| | - | release the temporary config; |

The method of the embodiments of the present disclosure is not limited to the IAB network, and may be extended to the terminal equipment (UE) in other communication networks. In addition, only the actions of the terminal equipment related to the embodiments of the present disclosure are described above, and for other actions of the terminal equipment, please refer to the related art.

In the embodiments of the present disclosure, when the method is applied to the IAB network, the contents of the embodiments of the first aspect and the embodiments of the second aspect may be incorporated into the embodiments of the third aspect of the present disclosure. For example, the terminal equipment in the embodiments of the present disclosure is the aforementioned IAB-node, and the operation 701 may be implemented by the method in the embodiments of the first aspect or by the method in the embodiments of the second aspect, the contents of which are incorporated herein and will not be repeated.

The above embodiments only exemplify the embodiments of the present disclosure, while the present disclosure is not limited thereto, and appropriate modifications can be made on the basis of the above embodiments. For example, each of the above embodiments may be used alone, or one or more of which may be combined.

According to the method of the embodiments of the present disclosure, the node can autonomously select the PDCP configuration, so the method is flexible, which enables the node to temporarily change the network configuration parameters according to its own situation, thereby reducing the signaling overhead and delay of the network, and improving the network performance.

### Embodiments of a Fourth Aspect

The embodiments of the present disclosure provide an apparatus for configuring an RRC message under dual connectivity. The apparatus may be, for example, an IAB-node in an IAB network, or one or more parts or components configured in the IAB-node.

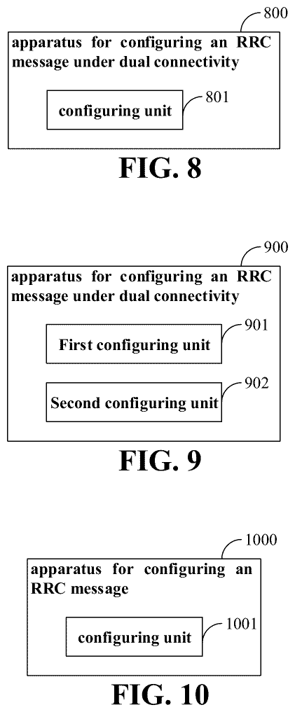

FIG. 8 illustrates a schematic diagram of an apparatus for configuring an RRC message under dual connectivity according to an embodiment of the present disclosure. Since the principle of solving problems by the apparatus is the same as that of the embodiments of the first aspect, the specific implementations can refer to those of the method of the embodiments of the first aspect, and the same contents will not be repeated.

As illustrated in FIG. 8, an apparatus 800 for configuring an RRC message under dual connectivity according to an embodiment of the present disclosure includes:
a configuring unit 801 configured to configure an RRC layer of an IAB-node as follows:
for an RRC message carrying an F1-C or an F1-C related traffic,
if a field flc-TransferPathNRDC′ in CellGroupConfig in RRC configuration indicates SCG and there is no BH RLC channel for F1-C on the SCG, the IAB-node uses split SRB2 via the SCG, regardless of primaryPath configuration of a PDCP entity of SRB2 configured by a network device;
and if the flc-TransferPathNRDC indicates both MCG and SCG and there is no BH RLC channel for F1-C on the SCG, the IAB-node can use split SRB2 via the SCG, regardless of primaryPath configuration of the PDCP entity of SRB2 configured by the network device.

In some embodiments, after the RRC message is transmitted, the primaryPath configuration is recovered to the original value.

In some embodiments, the configuring unit 801 configures the IE flc-TransferPathNRDC of the RRC layer of the IAB-node as described above.

In some embodiments, the IAB-node is configured with the MCG and the SCG.

In some embodiments, the IAB-node exchanges F1-AP messages or F1-C related IP packets sealed in an SCTP and/or IP with an MN via an SN using an NR access network, and exchanges F1-U traffics with the MN using a backhaul link.

In the above embodiments, the split SRB2 is used to transmit the F1-AP messages or the F1-C related IP packets sealed in the SCTP and/or IP between the IAB-node and the SN, and the F1-AP messages or the F1-C related IP packets sealed in the SCTP and/or IP are transferred as a container between the SN and the MN via an XnAP.

FIG. 9 illustrates another schematic diagram of an apparatus for configuring an RRC message under dual connectivity according to an embodiment of the present disclosure. Since the principle of solving problems by the apparatus is the same as that of the embodiments of the second aspect, the specific implementations can refer to those of the method of the embodiments of the second aspect, and the same contents will not be repeated.

As illustrated in FIG. 9, an apparatus 900 for configuring an RRC message under dual connectivity according to an embodiment of the present disclosure includes:
a first configuring unit 901 configured to configure an RRC layer of an IAB-node as follows:
for transmission of a ULInformationTransfer message, if there is a need to transfer F1-C related information, including the F1-C related information in dedicatedInfoFlc;
and if flc-TransferPathNRDC′ indicates SCG, or if flc-TransferPathNRDC′ indicates both MCG and SCG and the IAB-node chooses the SCG for transmission of the F1-C related information, using split SRB2 via the SCG, regardless of primaryPath configuration of a PDCP entity of SRB2 configured by a network device.

In the embodiments of the present disclosure, as illustrated in FIG. 9, the apparatus 900 for configuring an RRC message under dual connectivity further includes:
a second configuring unit 902 configured to configure the PDCP layer of the IAB-node.

In some embodiments, after the above message is transmitted, the primaryPath configuration is recovered to the original value.

In the above embodiments, the first configuring unit 901 may further configure the IAB-node to perform the following action:
including no other information unrelated to the IAB in the message.

In some embodiments, using split SRB2 via the SCG, regardless of primaryPath configuration of a PDCP entity of SRB2 configured by a network device includes: setting the primaryPath configuration to refer to the SCG.

In the above embodiments, in some implementations, the first configuring unit 901 may further configure the IAB-node to perform at least one of the following actions:
including no other information unrelated to the IAB in the message;
indicating to a lower layer that the primaryPath configuration is only used for the message.

In the above implementations, the second configuring unit 902 configures the PDCP layer of the IAB-node as follows:
when submitting a PDCP PDU to a lower layer, a transmitting PDCP entity submits the PDCP PDU to a primary RLC entity;
if an upper layer indicates that the primaryPath configuration is only used for the message, setting the primary RLC entity as an RLC entity on MCG after submitting the PDCP PDU to the primary RLC entity.

In the above embodiments, in some other implementations, the first configuring unit 901 may further configure the IAB-node to perform at least one of the following actions:
including no other information unrelated to the IAB in the message;
setting a first configuration in PDCP-Config IE to be TRUE, the first configuration being used to indicate that PDCP-Config of a bearer of the current configuration or a primaryPath configuration in PDCP-Config is an autonomous configuration from an upper layer of a local node.

In the above implementations, the bearer is SRB2, but the present disclosure is not limited thereto.

In the above implementations, the second configuring unit 902 configures the PDCP layer of the IAB-node as follows:
when submitting a PDCP PDU to a lower layer, a transmitting PDCP entity submits the PDCP PDU to a primary RLC entity;
and if the first configuration is configured and is set to TRUE, at least one of the following actions is performed:
setting the primary RLC entity as an RLC entity on the MCG after submitting the PDCP PDU to the primary RLC entity; and
setting the first configuration to be FALSE.

In some embodiments, using split SRB2 via the SCG, regardless of primaryPath configuration of a PDCP entity of SRB2 configured by a network device includes:
indicating to a lower layer that an SCG path is used to transmit the message.

In the above embodiments, the first configuring unit 901 may further configure the IAB-node to perform at least one of the following actions:
including no other information unrelated to the IAB in the message;
indicating to a lower layer that the primaryPath configuration is only used for the message.

In the above embodiments, the second configuring unit 902 configures the PDCP layer of the IAB-node as follows:
when receiving, from the upper layer, a PDCP SDU and an indication for using a SCG path for the SDU, ignoring a configured primary RLC entity and submitting a corresponding PDCP PDU to a secondary RLC entity.

In some embodiments, using split SRB2 via the SCG, regardless of primaryPath configuration of a PDCP entity of SRB2 configured by a network device includes: indicating to a lower layer via a second configuration in a PDCP configuration of the RRC layer of the IAB-node that an SCG path is used to transmit a next message needing to be transmitted via a current bearer.

In the above embodiments, the first configuring unit 901 may further configure the IAB-node to perform at least one of the following actions:
including no other information unrelated to the IAB in the message;
setting a first configuration in PDCP-Config IE to be TRUE, the first configuration being used to indicate that PDOP-Config of a bearer of the current configuration or a primaryPath configuration in PDCP-Config is an autonomous configuration from an upper layer of a local node.

In the above embodiments, the bearer is SRB2, but the present disclosure is not limited thereto.

In the above embodiments, the second configuring unit 902 configures the PDCP layer of the IAB-node as follows:
when receiving a PDCP SDU from the upper layer, if the second configuration is set to TRUE, performing at least one of the following actions:
ignoring a configured primary RLC entity and submitting a corresponding PDCP PDU to a secondary RLC entity;
setting the second configuration to be False.

In some embodiments, the IAB-node is configured with the MCG and the SCG.

In some embodiments, the IAB-node exchanges F1-AP messages or F1-C related IP packets sealed in an SCTP and/or IP with an MN via an SN using an NR access network, and exchanges F1-U traffics with the MN using a backhaul link.

In the above embodiments, the split SRB2 is used to transmit the F1-AP messages or the F1-C related IP packets sealed in the SCTP and/or IP between the IAB-node and the SN, and the F1-AP messages or the F1-C related IP packets sealed in the SCTP and/or IP are transferred as a container between the SN and the MN via an XnAP.

The embodiments of the present disclosure further provide an apparatus for configuring an RRC message. Since the principle of solving problems by the apparatus is the same as that of the embodiments of the third aspect, the specific implementations can refer to those of the method of the embodiments of the third aspect, and the same contents will not be repeated.

As illustrated in FIG. 10, an apparatus 1000 for configuring an RRC message according to an embodiment of the present disclosure includes:
a configuration unit 1001 configured to perform autonomous configuration on a PDCP entity to which an SRB carrying an RRC message corresponds before an RRC layer of a terminal equipment submits the RRC message to a lower layer.

In some embodiments, the autonomous configuration includes:
an PDCP-Config IE of the RRC layer of the terminal equipment includes a third configuration, the third configuration being used to indicate that the PDCP-Config IE of a bearer of the current configuration is an autonomous configuration from a local node, and configuration parameters in the PDCP-Config IE being applied for a next message needing to be transmitted via the bearer.

In some embodiments, when the upper layer requests PDCP reconfiguration and the third configuration is set to TRUE, the configuration unit 1001 stores reconfiguration information as a temporary configuration parameter, and associates a COUNT value of a next PDCP SDU to be transmitted with the temporary configuration parameter to indicate that the next PDCP SDU to be transmitted uses the temporary configuration parameter.

In some embodiments, if the COUNT value of the next PDCP SDU to be transmitted is associated with the temporary configuration parameter, the configuration unit 1001 submits the PDCP SDU using the temporary configuration parameter.

In some embodiments, the configuration unit 1001 releases the temporary configuration parameter after submitting the PDCP SDU using the temporary configuration parameter.

It should be noted that only the parts or modules related to the present disclosure have been described above, but the present disclosure is not limited thereto. The apparatuses 800, 900 and 1000 of the embodiments of the present disclosure may further include other parts or modules, and for the specific contents thereof, please refer to the related art.

In addition, for the sake of simplicity, FIGS. 8 to 10 only exemplarily illustrate the connection relationships or signal trends between the parts or modules, but it should be clear to those skilled in the art that various related arts such as bus connection may be adopted. The above parts or modules may be implemented by hardware facilities such as processor, memory, transmitter, receiver, etc., which is not limited herein.

According to the apparatus of the embodiments of the present disclosure, the node can autonomously select the PDCP configuration, so the apparatus is flexible, which enables the node to temporarily change the network configuration parameters according to its own situation, thereby reducing the signaling overhead and delay of the network, and improving the network performance.

### Embodiments of a Fifth Aspect

The embodiments of the present disclosure provide an IAB system, including an IAB-node, which is configured to perform the method according to the embodiments of any of the first to third aspects. The actions of the IAB-node have been described in detail in the embodiments of the first to third aspects, the contents of which are incorporated herein and will not be repeated.

The embodiments of the present disclosure also provide a communication system, including a terminal equipment and a network device, wherein the terminal equipment is configured to perform the method according to the embodiments of the third aspect. The actions of the terminal equipment have been described in detail in the embodiments of the third aspect, the contents of which are incorporated herein and will not be repeated.

The embodiments of the present disclosure further provide an IAB-node.

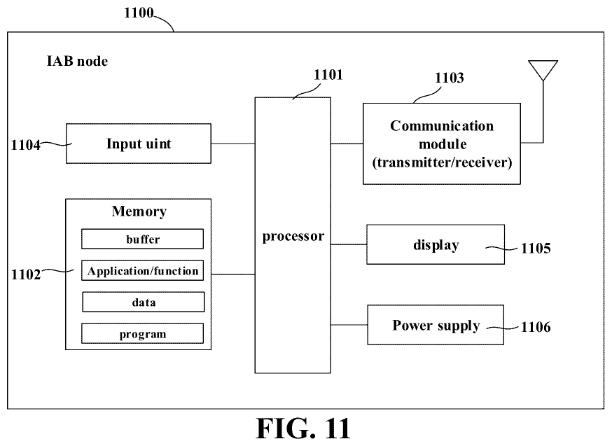

FIG. 11 is a schematic diagram of an IAB-node according to an embodiment of the present disclosure. As illustrated in FIG. 11, the IAB-node 1100 may include a processor 1101, and a memory 1102 storing data and a program and coupled to the processor 1101. It should be noted that the figure is exemplary, and other types of structures may also be used to supplement or replace this structure to realize a telecommunication function or other functions.

For example, the processor 1101 may be configured to execute the program to implement the method according to the embodiments of the first or second aspect.

As illustrated in FIG. 11, the IAB-node 1100 may further include a communication module 1103, an input unit 1104, a display 1105, and a power supply 1106. In which, the functions of the above parts are similar to those of the related art, and will not be described here. It should be noted that the IAB-node 1100 does not necessarily include all the parts illustrated in FIG. 11, and the above parts are not essential. In addition, the IAB-node 1100 may further include parts not illustrated in FIG. 11, and the related art may be referred to.

The embodiments of the present disclosure further provide a terminal equipment, which may be, for example, UE, but the present disclosure is not limited thereto, and any other equipment may be possible.

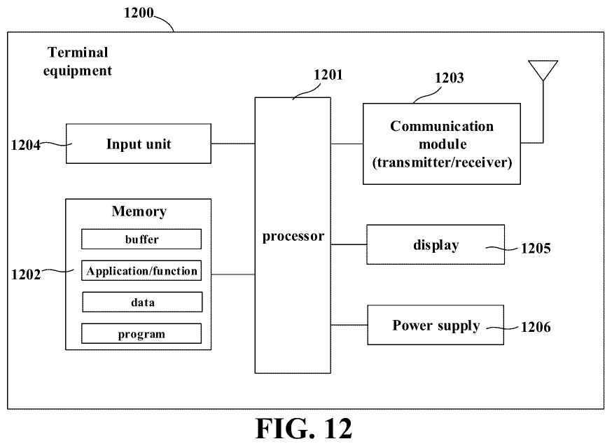

FIG. 12 illustrates a schematic diagram of a terminal equipment according to an embodiment of the present disclosure. As illustrated in FIG. 12, the terminal equipment 1200 may include a processor 1201, and a memory 1202 storing data and a program and coupled to the processor 1201. It should be noted that the figure is exemplary, and other types of structures may also be used to supplement or replace this structure to realize a telecommunication function or other functions.

For example, the processor 1201 may be configured to execute the program to implement the method according to the embodiments of the first aspect.

As illustrated in FIG. 12, the terminal equipment 1200 may further include a communication module 1203, an input unit 1204, a display 1205, and a power supply 1206. In which, the functions of the above parts are similar to those of the related art, and will not be described here. It should be noted that the terminal equipment 1200 does not necessarily include all the parts illustrated in FIG. 12, and the above parts are not essential. In addition, the terminal equipment 1200 may further include parts not illustrated in FIG. 12, and the related art may be referred to.

The embodiments of the present disclosure further provide a computer-readable program, wherein when executed in an IAB-node, the program causes a computer to perform the method according to the embodiments of the first or second aspect in the IAB-node.

The embodiments of the present disclosure further provide a storage medium storing a computer-readable program, wherein the computer-readable program causes a computer to perform the method according to the embodiments of the first or second aspect in an IAB-node.

The embodiments of the present disclosure further provide a computer-readable program, wherein when executed in a terminal equipment, the program causes a computer to perform the method according to the embodiments of the third aspect in the terminal equipment.

The embodiments of the present disclosure further provide a storage medium storing a computer-readable program, wherein the computer-readable program causes a computer to perform the method according to the embodiments of the third aspect in a terminal equipment.

The above apparatus and method of the present disclosure may be implemented by hardware, or may be implemented by hardware in combination with software. The present disclosure relates to a computer readable program which, when executed by a logic unit, causes the logic unit to implement the apparatus or constituent parts described above, or causes the logic unit to implement the various methods or steps described above. The logic unit for example is a field programmable logic unit, a microprocessor, a processor used in a computer, etc. The present disclosure further relates to a storage medium for storing the above program, such as a hard disk, a magnetic disk, an optical disk, a DVD, a flash memory, etc.

The method/apparatus described in conjunction with the embodiments of the present disclosure may be embodied directly as hardware, a software module executed by a processor, or a combination of the both. For example, one or more of the functional block diagrams and/or one or more combinations thereof illustrated in the drawings may correspond to both software modules of a computer program flow and hardware modules. These software modules may respectively correspond to the steps illustrated in the drawings. These hardware modules may be implemented, for example, by solidifying these software modules using a field programmable gate array (FPGA).

The software module may reside in a RAM memory, a flash memory, a ROM memory, an EPROM memory, an EEPROM memory, a register, a hard disk, a removable disk, a CD-ROM, or any other form of storage medium known in the art. A storage medium may be coupled to the processor such that the processor can read information therefrom and write information thereto, or the storage medium may be an integral part of the processor. The processor and the storage medium may reside in an ASIC. The software module may be stored in a memory of a mobile terminal or may be stored in a memory card insertable into the mobile terminal. For example, if a device (e.g., a mobile terminal) employs a MEGA-SIM card with a large capacity or a large-capacity flash memory device, the software module may be stored in the MEGA-SIM card or the large-capacity flash memory device.

One or more of the functional blocks and/or one or more combinations thereof depicted in the drawings may be implemented as a general purpose processor, a digital signal processor (DSP), an application specific integrated circuit (ASIC), a field programmable gate array (FPGA) or any other programmable logic device, a discrete gate or a transistor logic device, a discrete hardware component, or any suitable combination thereof designed to perform the functions described in the present disclosure. One or more of the functional blocks and/or one or more combinations thereof depicted in the drawings may also be implemented as a combination of computing devices, e.g., a combination of a DSP and a microprocessor, a plurality of microprocessors, one or more microprocessors in communication with the DSP, or any other such configuration.

The present disclosure is described as above in conjunction with the specific embodiments, but it should be clear to those skilled in the art that these descriptions are exemplary and do not limit the scope of the present disclosure. Those skilled in the art can make various variations and modifications to the present disclosure according to the spirit and principles of the present disclosure, and these variations and modifications are within the scope of the present disclosure.

Regarding the above implementations disclosed in the embodiments, the following supplements are also disclosed:

1. A method for configuring an RRC message under dual connectivity, wherein the method includes:
an IAB-node configures an RRC layer as follows:
for an RRC message carrying an F1-C or an F1-C related traffic,
if a field flc-TransferPathNRDC in CellGroupConfig in RRC configuration indicates SCG and there is no BH RLC channel for F1-C on the SCG, the IAB-node uses split SRB2 via the SCG, regardless of primaryPath configuration of a PDCP entity of SRB2 configured by a network device;
and if the flc-TransferPathNRDC indicates both MCG and SCG and there is no BH RLC channel for F1-C on the SCG, the IAB-node may use split SRB2 via the SCG, regardless of primaryPath configuration of the PDCP entity of SRB2 configured by the network device.

2. The method according to supplement 1, wherein the primaryPath configuration is recovered to an original value after the RRC message is transmitted.

3. The method according to supplement 1 or 2, wherein the IAB-node performs the above configuration on an IE flc-TransferPathNRDC of the RRC layer thereof.

4. A method for configuring an RRC message under dual connectivity, wherein the method includes:
an IAB-node configures an RRC layer as follows:
for transmission of a ULInformationTransfer message, if there is a need to transfer F1-C related information, including the F1-C related information in dedicatedInfoFlc;
and if flc-TransferPathNRDC indicates SCG, or if flc-TransferPathNRDC indicates both MCG and SCG, and the IAB-node chooses the SCG for transmission of the F1-C related information, using split SRB2 via the SCG, regardless of primaryPath configuration of a PDCP entity of SRB2 configured by a network device.

5. The method according to supplement 4, wherein the primaryPath configuration is recovered to an original value after the message is transmitted.

6. The method according to supplement 4, wherein using split SRB2 via the SCG, regardless of primaryPath configuration of a PDCP entity of SRB2 configured by a network device includes:
setting the primaryPath configuration to refer to the SCG.

7. The method according to supplement 6, wherein the IAB-node further performs an action of:
indicating to a lower layer that the primaryPath configuration is only used for the message.

8. The method according to supplement 6, wherein the IAB-node further performs an action of:
setting a first configuration in PDCP-Config IE to be TRUE, the first configuration being used to indicate that PDCP-Config of a bearer of the current configuration or a primaryPath configuration in PDCP-Config is an autonomous configuration from an upper layer of a local node.

9. The method according to supplement 8, wherein the bearer is SRB2.

10. The method according to supplement 4, wherein using split SRB2 via the SCG, regardless of primaryPath configuration of a PDCP entity of SRB2 configured by a network device includes:
indicating to a lower layer that an SCG path is used to transmit the message.

11. The method according to supplement 4, wherein using split SRB2 via the SCG, regardless of primaryPath configuration of a PDCP entity of SRB2 configured by a network device includes:
indicating to a lower layer via a second configuration in a PDCP configuration of the RRC layer of the IAB-node that an SCG path is used to transmit a next message needing to be transmitted via a current bearer.

12. The method according to any one of supplements 4 to 11, wherein the IAB-node further performs an action of:
including no other information unrelated to the IAB in the message.

13. The method according to supplement 6 or 7, wherein the method further includes:
the IAB-node configures the PDCP layer as follows:
when submitting a PDCP PDU to a lower layer, a transmitting PDCP entity submits the PDCP PDU to a primary RLC entity;
if an upper layer indicates that the primaryPath configuration is only used for the message, setting the primary RLC entity as an RLC entity on MCG after submitting the PDCP PDU to the primary RLC entity.

14. The method according to supplement 8, wherein the method further includes:
the IAB-node configures the PDCP layer as follows:
when submitting a PDCP PDU to a lower layer, a transmitting PDCP entity submits the PDCP PDU to a primary RLC entity;
and if the first configuration is configured and is set to TRUE, at least one of the following actions is performed:
setting the primary RLC entity as an RLC entity on the MCG after submitting the PDCP PDU to the primary RLC entity; and
setting the first configuration to be FALSE.

15. The method according to supplement 10, wherein the method further includes:
the IAB-node configures the PDCP layer as follows:
when receiving, from the upper layer, a PDCP SDU and an indication for using the SCG for an SDU, ignoring a configured primary RLC entity and submitting a corresponding PDCP PDU to a secondary RLC entity.

16. The method according to supplement 11, wherein the method further includes:
the IAB-node configures the PDCP layer as follows:
when receiving a PDCP SDU from the upper layer, if the second configuration is set to TRUE, performing at least one of the following actions:
ignoring a configured primary RLC entity and submitting a corresponding PDCP PDU to a secondary RLC entity;
setting the second configuration to be False.

17. The method according to any one of supplements 1 to 16, wherein the IAB-node is configured with the MCG and the SCG.

18. The method according to any one of supplements 1 to 16, wherein the IAB-node exchanges F1-AP messages or F1-C related IP packets sealed in an SCTP and/or IP with an MN via an SN using an NR access network, and exchanges F1-U traffics with the MN using a backhaul link.

19. The method according to supplement 18, wherein the split SRB2 is used to transmit the F1-AP messages or the F1-C related IP packets sealed in the SCTP and/or IP between the IAB-node and the SN, and the F1-AP messages or the F1-C related IP packets sealed in the SCTP and/or IP are transferred as a container between the SN and the MN via an XnAP.

20. A method for configuring an RRC message, wherein the method includes:
performing, by a terminal equipment, autonomous configuration on a PDCP entity to which an SRB carrying an RRC message corresponds before an RRC layer submits the RRC message to a lower layer.

21. The method according to supplement 20, wherein the autonomous configuration includes:
an PDCP-Config IE of the RRC layer of the terminal equipment includes a third configuration, the third configuration being used to indicate that the PDCP-Config IE of a bearer of the current configuration is an autonomous configuration from a local node, and configuration parameters in the PDCP-Config IE being applied for a next message needing to be transmitted via the bearer.

22. The method according to supplement 21, wherein the method includes:
when an upper layer requests PDCP reconfiguration and the third configuration is set to TRUE, the terminal equipment stores reconfiguration information as a temporary configuration parameter, and associates a COUNT value of a next PDCP SDU to be transmitted with the temporary configuration parameter to indicate that the next PDCP SDU to be transmitted uses the temporary configuration parameter.

23. The method according to supplement 22, wherein the method further includes:
if the COUNT value of the next PDCP SDU to be transmitted is associated with the temporary configuration parameter, the terminal equipment submits the PDCP SDU using the temporary configuration parameter.

24. The method according to supplement 23, wherein the method further includes:
the terminal equipment releases the temporary configuration parameter after submitting the PDCP SDU using the temporary configuration parameter.

25. An IAB-node, including a memory and a processor, wherein the memory stores a computer program, and the processor is configured to execute the computer program to implement the method according to any one of supplements 1 to 24.

26. A terminal equipment, including a memory and a processor, wherein the memory stores a computer program, and the processor is configured to execute the computer program to implement the method according to any one of supplements 20 to 24.

27. An IAB system, including an IAB-node configured to perform the method according to any one of supplements 1 to 24.

28. A communication system, including a terminal equipment and a network device, wherein the terminal equipment is configured to perform the method according to any one of supplements 20 to 24.

1. An apparatus comprising:
configuring processor circuitry configured to perform autonomous configuration on a PDCP entity to which an SRB carrying a RRC message corresponds before an RRC layer of a terminal equipment submits the RRC message to a lower layer.

2. The apparatus according to claim 1, wherein the autonomous configuration comprises:
an PDCP-Config IE of the RRC layer of the terminal equipment includes a third configuration, the third configuration being used to indicate that the PDCP-Config IE of a bearer of the current configuration is autonomous configuration from the local node, and configuration parameters in the PDCP-Config IE being applied for the next message needing to be transmitted via the bearer.

3. The apparatus according to claim 2, wherein,
when the upper layer requests PDCP reconfiguration and the third configuration is set to TRUE, the configuring processor circuitry stores the reconfiguration information as a temporary configuration parameter, and associates a COUNT value of a next PDCP SDU to be transmitted with the temporary configuration parameter, so as to indicate that the next PDCP SDU to be transmitted uses the temporary configuration parameter.

4. The apparatus according to claim 3, wherein,
if the COUNT value of the next PDCP SDU to be transmitted is associated with the temporary configuration parameter, the configuring processor circuitry submits the PDCP SDU using the temporary configuration parameter.

5. The apparatus according to claim 4, wherein,
the configuring processor circuitry releases the temporary configuration parameter after submitting the PDCP SDU using the temporary configuration parameter.

6. An apparatus for configuring a radio resource control (RRC) message under dual connectivity, the apparatus comprising:
configuring processor circuitry configured to configure an RRC layer of an integrated access and backhaul (IAB) node as follows:
for an RRC message carrying a control plane traffic of an F1 interface (F1-C) or an F1-C related traffic,
if a field flc-TransferPathNRDC in CellGroupConfig in RRC configuration indicates secondary cell group (SCG) and there is no backhaul radio link control (BH RLC) channel for F1-C on the SCG, the IAB node uses a split signaling radio bearer 2 (SRB2) via the SCG, regardless of primaryPath configuration of a packet data convergence protocol (PDCP) entity of SRB2 configured by a network device;
and if the flc-TransferPathNRDC indicates both master cell group (MCG) and SCG and there is no BH RLC channel for F1-C on the SCG, the IAB node may use split SRB2 via the SCG, regardless of primaryPath configuration of the PDCP entity of SRB2 configured by the network device.

7. The apparatus according to claim 6, wherein the primaryPath configuration is recovered to an original value after the RRC message is transmitted.

8. The apparatus according to claim 6, wherein the configuring processor circuitry performs the above configuration on an information element (IE) flc-TransferPathNRDC of the RRC layer of the IAB node.

9. An apparatus for configuring an RRC message under dual connectivity, the apparatus comprising:
first configuring processor circuitry configured to configure an RRC layer of an IAB node as follows:
for transmission of a ULInformationTransfer message, if there is a need to transfer F1-C related information, including the F1-C related information in dedicatedInfoFlc;
and if flc-TransferPathNRDC indicates SCG, or if flc-TransferPathNRDC indicates both MCG and SCG and the IAB node chooses the SCG for transmission of the F1-C related information, using split SRB2 via the SCG, regardless of primaryPath configuration of a PDCP entity of SRB2 configured by a network device.
